(19) United States
(12) Patent Application Publication
(10) Pub. No.: US 2021/0212255 A1
(43) Pub. Date: Jul. 15, 2021

(54) Landscaping Trimmer

(71) Applicant: Sharon Scott, Val Therese (CA)

(72) Inventor: Sharon Scott, Val Therese (CA)

(21) Appl. No.: 17/145,585

(22) Filed: Jan. 11, 2021

Related U.S. Application Data
(60) Provisional application No. 62/961,368, filed on Jan. 15, 2020.

(51) Int. Cl. A01D 34/74; A01D 34/685; A01D 34/82; A01D 34/84

(52) U.S. Cl. CPC A01D 34/74; A01D 34/685; A01D 2034/6843; A01D 34/84; A01D 34/824

(57) ABSTRACT

An improved landscaping trimmer is provided. The device includes a housing having an open lower end. A motor is disposed within the housing and is operably connected to a plurality of cutting heads extending through the open lower end. The plurality of cutting heads are disposed in an offset pattern defining an upper portion of the housing and a lower portion of the housing. Each of the plurality of cutting heads is affixed to the housing in a floating arrangement. A plurality of blades extends from each of the plurality of cutting heads, whereupon actuation of the motor, the plurality of cutting heads rotate about the longitudinal axis. A handle extends from the housing, wherein the handle includes a control that activates the motor. A plurality of wheels is affixed to the housing, wherein each wheel is disposed adjacent to one cutting head of the plurality of cutting heads.

### CROSS REFERENCE TO RELATED APPLICATIONS

This application claims the benefit of U.S. Provisional Application No. 62/961,368 filed on Jan. 15, 2020. The above identified patent application is herein incorporated by reference in its entirety to provide continuity of disclosure.

### BACKGROUND OF THE INVENTION

The present invention relates to landscaping trimmers. More particularly, the present invention pertains to an improved landscaping trimmer with floating cutting heads that is dimensioned to contour around common landscaping obstructions, such as trees.

Many individuals struggle to utilize traditional landscaping trimmers, as traditional landscaping trimmers require the user to constantly support the trimmer head above the ground surface. Alternatively, some landscaping trimmers are equipped with shoulder straps to distribute the weight of the trimmer across the user's torso. However, this still results in the user supporting the entirety of the trimmer's weight during use. Additionally, traditional landscaping trimmers often produce uneven lengths of grass, as the user's support of the trimmer above the ground surface can vary during use. Furthermore, many traditional landscaping trimmers can be difficult to operate in close proximity to common landscaping obstacles, such as trees. The user must be careful not to contact the obstacle with the trimmer's cutting element to reduce the risk of debris or the obstacle itself being thrown from the trimmer, possibly resulting in injury to the user. Therefore, a landscaping trimmer that supports itself while being readily navigable amid obstacles is desired.

In light of the devices disclosed in the known art, it is submitted that the present invention substantially diverges in design elements from the known art and consequently it is clear that there is a need in the art for an improvement to existing landscaping trimmers. In this regard, the instant invention substantially fulfills these needs.

### SUMMARY OF THE INVENTION

In view of the foregoing disadvantages inherent in the known types of landscaping trimmers now present in the known art, the present invention provides a landscaping trimmer wherein the same can be utilized for providing convenience for the user when trimming grass and weeds on an uneven ground surface and around trees or other obstacles.

The present system comprises a housing having an open lower end. A motor is disposed within the housing and operably connected to a plurality of cutting heads extending through the open lower end. The plurality of cutting heads are disposed in an offset pattern defining an upper portion of the housing and a lower portion of the housing. Each of the plurality of cutting heads is affixed to the housing in a floating arrangement, such that each of the plurality of cutting heads is selectively movable along a longitudinal axis thereof. A plurality of blades extends from each of the plurality of cutting heads. A handle is affixed to the housing wherein the handle includes a control configured to activate the motor when actuated. Upon activation of the motor, the plurality of cutting heads rotate about the longitudinal axis. A plurality of wheels is affixed to the housing, wherein each wheel of the plurality of wheels is disposed adjacent to one cutting head of the plurality of cutting heads. In some embodiments, a spherical roller is rotatably affixed within a distal end of each cutting head.

In some embodiments, the motor is operably connected to each cutting head via a series of belts. In another embodiment, the handle comprises a telescopic construction configured to selectively adjust in length. In other embodiments, an arcuate recess is defined within the housing between the upper portion and the lower portion on each side of the housing. In yet another embodiment, the plurality of cutting heads each comprise a spring therein, wherein the spring is affixed to the housing and biases the cutting head to an extended position. In some embodiments, a flexible shroud is disposed over the spring between the cutting head and the housing. In another embodiment, a motor compartment is disposed on an upper side of the housing, wherein the motor is disposed within the motor compartment. In other embodiments, the handle is affixed to the motor compartment. In yet another embodiment, each wheel of the plurality of wheels is rotatably affixed to the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the improved landscaping trimmer.

FIG. 2 shows a top-down semi-transparent view of an embodiment of the improved landscaping trimmer.

FIG. 3 shows a cross-sectional view of an embodiment of the improved landscaping trimmer.

FIG. 4 shows a cross-sectional view of a cutting head of an embodiment of the improved landscaping trimmer.

FIG. 5 shows a perspective view of an embodiment of the improved landscaping trimmer in use.

### DETAILED DESCRIPTION OF THE INVENTION

Reference is made herein to the attached drawings. Like reference numerals are used throughout the drawings to depict like or similar elements of the landscaping trimmer. The figures are intended for representative purposes only and should not be considered to be limiting in any respect.

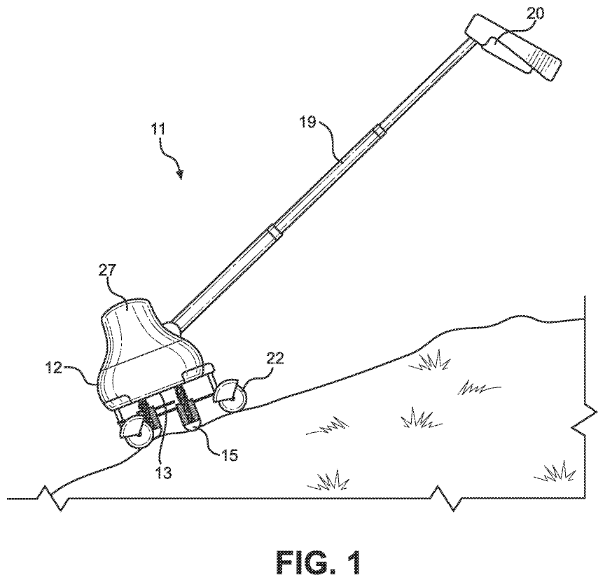

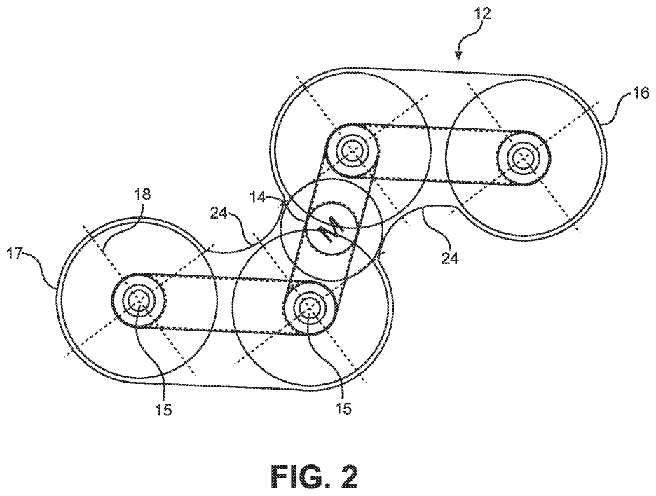

Referring now to FIG. 1, there is shown a perspective view of an embodiment of the improved landscaping trimmer. The improved landscaping trimmer 11 comprises a housing 12 having an open lower end 13. A plurality of cutting heads 15 are affixed to the housing 12 such that the plurality of cutting heads 15 extend through the open lower end 13. A motor (as shown in FIG. 2, 14) is disposed within the housing 12 and is operably connected to each of the plurality of cutting heads 15, such that the motor rotates the plurality of cutting heads 15 about a longitudinal axis thereof. In this manner, the plurality of cutting heads 15 spin at a sufficient rate to cut grass, weeds, or the like to a desired height. In the shown embodiment, the housing 12 further comprises a motor compartment 27 on an upper side thereof, wherein the motor compartment 27 houses the motor therein. In the illustrated embodiment, the housing 12 further comprises a plurality of wheels 22 affixed thereto, wherein the plurality of wheels 22 facilitate transport of the improved landscaping trimmer 11 across a ground surface. In some embodiments, the plurality of wheels 22 are pivotally affixed to the housing 12, such that the plurality of wheels 22 increase maneuverability of the improved landscaping trimmer 11.

A handle 19 is affixed to the housing 12, wherein the handle 19 further comprises a control 20 on an end thereof. The control 20 is configured to activate the motor, such that the plurality of cutting heads 15 rotate to trim grass and weeds. In the shown embodiment, the handle 19 is affixed to the motor compartment 27, such that the handle 19 is elevated relative to the open lower end 13 of the housing 12. In this manner, as the angle of the handle 19 relative to the housing 12 is nearer to parallel with the ground surface, the user can readily maneuver the improved landscaping trimmer 11 as less force is directed towards the ground surface. In the illustrated embodiment, the handle 19 comprises a telescopic configuration, such that the handle 19 is selectively adjustable in length. In some embodiments, the handle 19 further comprises an ergonomic grip on an end thereof adjacent to the control 20, wherein the ergonomic grip includes a plurality of finger wells thereon to improve user comfort. In another embodiment, the handle 19 is pivotally affixed to the housing 12, allowing the handle 19 to be maneuvered relative to the housing 12. In some such embodiments, the handle 19 is pivotable along a 45-degree arc on the housing 12.

Referring now to FIG. 2, there is shown a top-down semi-transparent view of an embodiment of the improved landscaping trimmer. The plurality of cutting heads 15 are disposed in an offset arrangement within the housing 12, such that the housing 12 defines an upper portion 16 and a lower portion 17. Each of the plurality of cutting heads 15 includes a plurality of blades 18 thereon. In the shown embodiment, a pair of cutting heads are disposed in each of the upper and lower portions 16, 17. In this way, the plurality of cutting heads 15 provide maximal coverage, allowing a large area to be trimmed simultaneously. In some embodiments, the plurality of cutting heads 15 are disposed such that the plurality of blades 18 overlap in coverage. In such embodiments, the motor 14 is configured to drive each of the cutting heads 15 at a consistent rate, such that the plurality of blades 18 of one cutting head 15 never contact the plurality of blades 18 of an adjacent cutting head 15. Additionally, in the illustrated embodiment, the offset distribution of cutting heads 15 defines an arcuate recess 24 between the upper and lower portions 16, 17 on opposing sides of the housing 12. In this manner, the arcuate recesses 24 allow the housing 12 to abut a substantially cylindrical or other rounded obstruction in a yard, such as a tree, to trim the grass and weeds immediately around the obstruction.

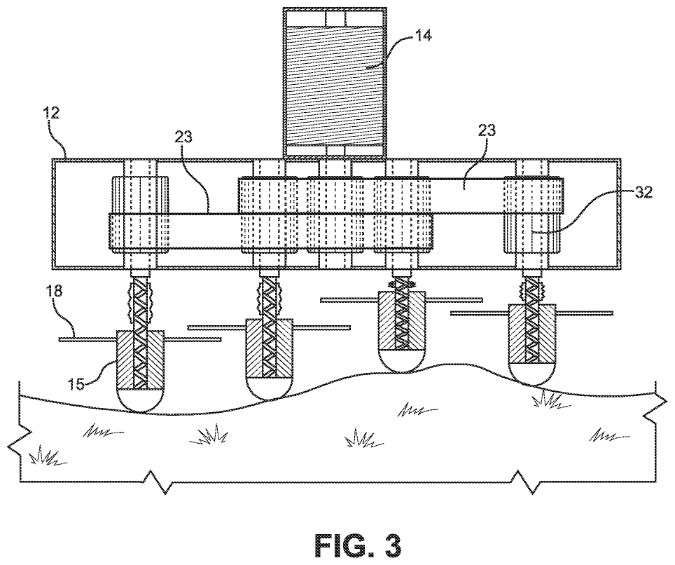

Referring now to FIG. 3, there is shown a cross-sectional view of an embodiment of the improved landscaping trimmer. In the illustrated embodiment, the motor 14 is operably connected to each of the plurality of cutting heads 15 via a series of belts 23 and drive shafts 32, wherein each cutting head 15 is affixed to a drive shaft 32. As the motor 14 is activated, a central motor shaft rotates, thereby driving the series of belts 23 to rotate each drive shaft 32, such that each cutting head 15 is rotated about a longitudinal axis thereof. In this manner, the plurality of blades 18 affixed to each cutting head 15 rotate to cut grass, weeds, and the like. In the shown embodiment, each of the plurality of cutting heads 15 is affixed to the housing 12 in a floating arrangement, such that a relative height of each cutting head 15 is selectively adjustable to allow the plurality of cutting heads 15 to traverse uneven terrain.

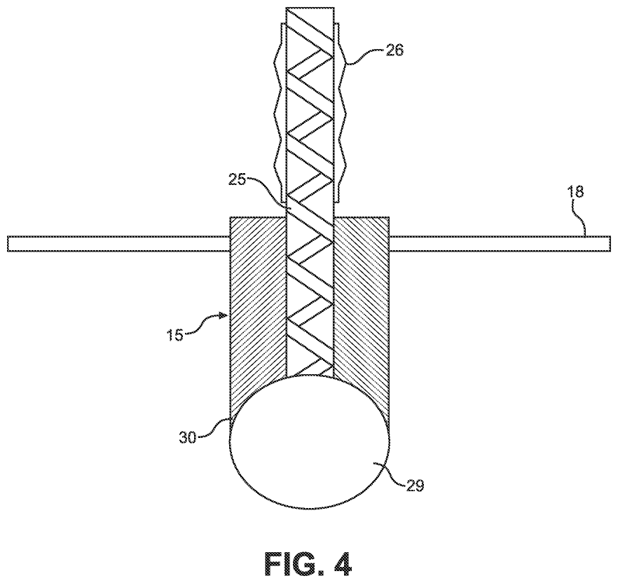

Referring now to FIG. 4, there is shown a cross-sectional view of a cutting head of an embodiment of the improved landscaping trimmer. In the shown embodiment, each cutting head 15 includes a plurality of blades 18 extending orthogonally from each cutting head 15. The plurality of blades 18 are contemplated to include rigid elements having sharpened edges, as well as flexible string trimmer elements. In some embodiments, the plurality of blades 18 are interchangeable to allow the user to replace blades that have become dull, damaged, or the like. In the illustrated embodiment, the plurality of blades 18 are disposed on an upper end of each cutting head 15, however, in alternate embodiments, the position of the plurality of blades 18 can be adjustable to allow a user to select a desired height at which grass or weeds will be trimmed.

In the shown embodiment, a spring 25 is disposed within each cutting head 15 along a longitudinal axis thereof, wherein the spring 25 is configured to allow the cutting head 15 to selectively adjust in height relative to the housing. In this manner, each cutting head 15 is disposed in a floating arrangement to accommodate uneven terrain. In such embodiments, a distal end 30 of the cutting head 15 directly contacts a ground surface, such that uneven terrain forces the cutting head 15 to upwards, thereby compressing the spring 25. Once the uneven terrain passes, the spring 25 biases the cutting head 15 downwards, ensuring grass and weeds are trimmed to an even height. In the shown embodiment, a flexible shroud 26 is disposed over the spring 25 between the housing and the cutting head 15, such that dirt and debris are prevented from interfering with the operation of the spring 25.

In the shown embodiment, a spherical roller 29 is rotatably affixed within the distal end 30 of each cutting head 15. The spherical roller 29 allows the cutting heads 15 to roll over the ground surface, such that the spherical roller 29 may replace the plurality of wheels in some embodiments, whereas other embodiments incorporate both. In embodiments lacking the spherical roller 29, the distal end 30 of the cutting head 15 comprises a rounded surface to minimize surface area of the cutting head 15 in contact with the ground surface, thereby minimizing frictional resistance, while maintaining the floating operation of the plurality of cutting heads 15.

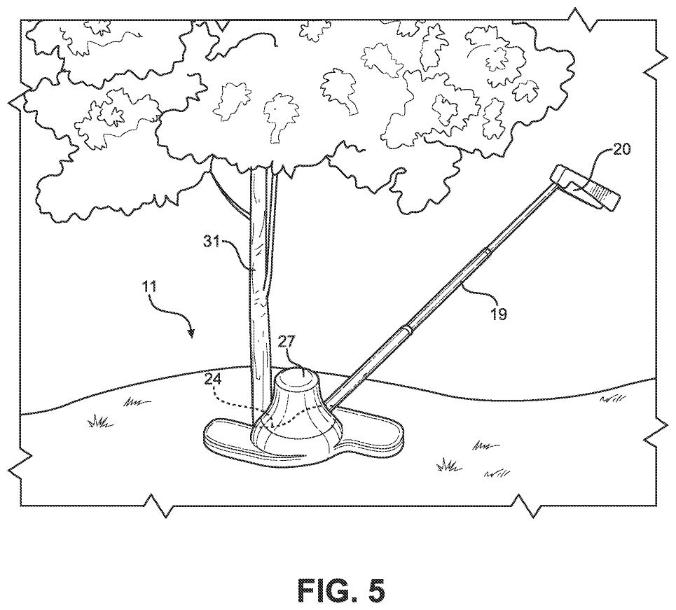

Referring now to FIG. 5, there is shown a perspective view of an embodiment of the improved landscaping trimmer in use. The improved landscaping trimmer 11 can be utilized to trim the length of grass, weeds, or the like in a yard. In one use, the user grasps an end of the handle 19 and actuates the control 20 to activate the motor. In some embodiments, the user can further adjust the angle of the handle 19 relative to the housing via the pivotal arrangement. As the motor is activated, the plurality of cutting heads are driven to rotate, driving the plurality of blades about a longitudinal axis of the plurality of cutting heads. The user can then maneuver the improved landscaping trimmer 11 about the yard to trim grass and weeds as desired. When an obstacle, such as a tree 31, is encountered, the user can maneuver the housing to abut the arcuate recess 24 of the housing against the tree 31, such that the grass and weeds immediately surrounding the tree can be trimmed to a desired length.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An improved landscaping trimmer, comprising:
a housing having an open lower end;
a motor disposed within the housing and operably connected to a plurality of cutting heads extending through the open lower end;
wherein the plurality of cutting heads are disposed in an offset pattern defining an upper portion of the housing and a lower portion of the housing;
wherein each of the plurality of cutting heads is affixed to the housing in a floating arrangement, such that each of the plurality of cutting heads is selectively movable along a longitudinal axis thereof;
a plurality of blades extending from each of the plurality of cutting heads;
a handle extending from the housing, wherein the handle includes a control configured to activate the motor when actuated;
whereupon activation of the motor, the plurality of cutting heads rotate about the longitudinal axis; and
a plurality of wheels affixed to the housing, wherein each wheel of the plurality of wheels is disposed adjacent to one cutting head of the plurality of cutting heads.

2. The improved landscaping trimmer of claim 1, wherein the motor is operably connected to each cutting head via a series of belts.

3. The improved landscaping trimmer of claim 1, wherein the handle comprises a telescopic construction configured to selectively adjust in length.

4. The improved landscaping trimmer of claim 1, wherein the handle is pivotally connected to the housing.

5. The improved landscaping trimmer of claim 1, wherein an arcuate recess is defined within the housing between the upper portion and the lower portion on each side of the housing.

6. The improved landscaping trimmer of claim 1, wherein the plurality of cutting heads each comprise a spring therein, wherein the spring is affixed to the housing and biases the cutting head to an extended position.

7. The improved landscaping trimmer of claim 6, further comprising a flexible shroud disposed over the spring between the cutting head and the housing.

8. The improved landscaping trimmer of claim 1, further comprising a motor compartment on an upper side of the housing, wherein the motor is disposed within the motor compartment.

9. The improved landscaping trimmer of claim 8, wherein the handle is affixed to the motor compartment.

10. The improved landscaping trimmer of claim 1, wherein each wheel of the plurality of wheels is rotatably affixed to the housing.

11. An improved landscaping trimmer, comprising:
a housing having an open lower end;
a motor disposed within the housing and operably connected to a plurality of cutting heads extending through the open lower end;
wherein the plurality of cutting heads are disposed in an offset pattern defining an upper portion of the housing and a lower portion of the housing;
wherein each of the plurality of cutting heads is affixed to the housing in a floating arrangement, such that each of the plurality of cutting heads is selectively movable along a longitudinal axis thereof;
a plurality of blades extending from each of the plurality of cutting heads;
a spherical roller rotatably disposed within each cutting head at a distal end thereof;
a handle extending from the housing, wherein the handle includes a control configured to activate the motor when actuated; and
whereupon activation of the motor, the plurality of cutting heads rotate about the longitudinal axis.

12. The improved landscaping trimmer of claim 11, wherein the motor is operably connected to each cutting head via a series of belts.

13. The improved landscaping trimmer of claim 11, wherein the handle comprises a telescopic construction configured to selectively adjust in length.

14. The improved landscaping trimmer of claim 11, wherein the handle is pivotally connected to the housing.

15. The improved landscaping trimmer of claim 11, wherein an arcuate recess is defined within the housing between the upper portion and the lower portion on each side of the housing.

16. The improved landscaping trimmer of claim 11, wherein the plurality of cutting heads each comprise a spring therein, wherein the spring is affixed to the housing and biases the cutting head to an extended position.

17. The improved landscaping trimmer of claim 16, further comprising a flexible shroud disposed over the spring between the cutting head and the housing.

18. The improved landscaping trimmer of claim 11, further comprising a motor compartment on an upper side of the housing, wherein the motor is disposed within the motor compartment.

19. The improved landscaping trimmer of claim 18, wherein the handle is affixed to the motor compartment.
